(19) United States
(12) Patent Application Publication
(10) Pub. No.: US 2012/0242307 A1
(43) Pub. Date: Sep. 27, 2012

(54) POWER SUPPLY CIRCUIT

(75) Inventor: Masanao Higuchi, Handa-city (JP)

(73) Assignee: DENSO CORPORATION, Kariya-city (JP)

(21) Appl. No.: 13/428,467

(22) Filed: Mar. 23, 2012

(30) Foreign Application Priority Data
Mar. 25, 2011 (JP) 2011-068289

(51) Int. Cl. G05F 1/46

(52) U.S. Cl. 323/273; 323/282; 323/284

(57) ABSTRACT

A power supply circuit includes: an N-type FET outputting electricity of an external power supply to a load; a drive line supplying the electricity from the external power supply to the FET; an output line outputting the electricity from the FET to the load; a charge device charging the electricity according to a potential difference between the drive line and the output line; a drive device in the drive line and applying a voltage to a gate of the FET higher than a source of FET so that the FET switches to be the on-state; a step-down device connected to the output line and reducing a voltage across the output line when the FET is in the off-state; and a current regulation device in the output line and regulating a flow of current from the load toward the step-down device.

### CROSS REFERENCE TO RELATED APPLICATION

This application is based on Japanese Patent Application No. 2011-68289 filed on Mar. 25, 2011, the disclosure of which is incorporated herein by reference.

### TECHNICAL FIELD

The present disclosure relates to a power source circuit for outputting electricity to a load.

### BACKGROUND

There is a power supply circuit provided with a field effect transistor and configured to output power corresponding to a load condition of a load portion by switching conduction between a drain and a source of the field effect transistor from an ON state to an OFF state and vice versa. For example, Patent Document 1 discloses a DC-to-DC converter provided with a P-channel MOS field effect transistor (PWM FET) and a control transistor as drive means for switching conduction between a drain and a source of the PWM FET to an ON state. According to the DC-to-DC converter of Patent Document 1, the PWM FET outputs power supplied to the source from a power supply portion to a load portion from the drain when a voltage with potential lower than potential at the source is applied to a gate by the control transistor. The DC-to-DC converter outputs power corresponding to a load condition of the load portion from the drain by changing a ratio of an ON state and an OFF state of conduction of the PWM FET, a so-called ON duty ratio.

Patent Document 1: JP-A-H03-24814

There is also a power supply circuit provided with an N-type field effect transistor less expensive and more compact than a P-type field effect transistor instead of the PWM FET used in Patent Document 1. The power supply circuit provided with an N-type field effect transistor outputs power supplied to a drain of the N-type field effect transistor to a load portion from a source. In the N-type field effect transistor, conduction between the drain and the source is switched to an ON state when a voltage with potential higher than potential at the source is applied to a gate.

There is a case where the power supply circuit provided with an N-type field effect transistor as described above includes a capacitor connected at one end portion to a drive line through which to supply power from an outside to the gate and connected at the other end portion to an output line through which to output power from the source to the load portion. When conduction of the N-type field effect transistor is in an OFF state, power in the output line is consumed by the load portion and a voltage across the output line therefore drops below a voltage across the drive line. Hence, the capacitor can be charged with power due to a potential difference between the drive line and the output line. The drive means, such as a control transistor, applies a voltage with potential higher than potential at the source to the gate using power supplied therein from the outside and power charged to the capacitor. Conduction of the N-type field effect transistor is thus switched to an ON state.

However, in a case where the load portion is in a light load condition, power consumed by the load portion is small. Hence, even when conduction of the N-type field effect transistor is in an OFF state, a voltage across the output line hardly drops. Further, there is a case where a voltage of power supplied from the power supply portion, such as an outside battery, drops in this instance for some reason. Then, because a potential difference between the drive line and the output line is no longer secured, the capacitor cannot be charged with power. The drive means therefore fails to apply a voltage with potential higher than potential at the source to the gate of the N-type field effect transistor and becomes unable to switch conduction between the drain and the source to an ON state. For these reasons, the power supply circuit becomes unable to continuously output power to the load portion from the source.

### SUMMARY

It is an object of the present disclosure to provide a power supply circuit capable of continuously outputting power corresponding to a load condition of a load even in a case where a voltage across an external power supply drops when the load is in a light load condition.

According to an example aspect of the present disclosure, a power supply circuit includes: an N-type field effect transistor for outputting electricity to a load via a source of the transistor, the electricity supplied from an external power supply via a drain of the transistor, wherein the transistor controls conduction between the drain and the source to switch between an on-state and an off-state so that the transistor controls the electricity to be output via the source according to a load condition of the load; a drive line for supplying the electricity from the external power supply to a gate of the transistor; an output line for outputting the electricity from the source to the load; a charge device for charging the electricity therein according to a potential difference between the drive line and the output line, wherein the charge device includes one end connecting to the drive line and the other end connecting to the output line; a drive device disposed in the drive line, wherein the drive device applies a voltage to the gate higher than a voltage of the source with using the electricity supplied from the external power supply and the electricity charged in the charge device so that the transistor switches the conduction to be the on-state; a step-down device connected to the output line, wherein the step-down device reduces a voltage across the output line when the conduction of the transistor is in the off-state; and a current regulation device disposed in the output line on a load side from both of a connection between the step-down device and the output line and a connection between the charge device and the output line, wherein the current regulation device regulates a flow of current from the load toward the step-down device.

In the above circuit, even in a case where a voltage across the external power supply drops when the load is in a light load condition, the power supply circuit can continuously output power corresponding to a load condition of the load.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a view schematically showing a configuration of a combination meter provided with a power supply circuit according to a first embodiment;

FIG. 2 is a circuit diagram showing a configuration of the power supply circuit according to the first embodiment;

FIGS. 3A to 3C are views each showing a variation of a voltage when the power supply circuit is outputting power to a display control MPU by pulse width modulation control, FIG. 3A showing a variation of a voltage across a drive line in a portion to which a drive line connecting portion of a capacitor is connected, FIG. 3B showing a variation of a voltage across an output line in a portion to which an output line connecting portion of the capacitor is connected, and FIG. 3C showing a variation of a voltage across the output line between a smoothing circuit and the display control MPU;

FIGS. 4A to 4C are views each showing a variation of a voltage when the power supply circuit is outputting power to the display control MPU by hysteresis control, FIG. 4A showing a variation of a voltage across the drive line in a portion to which the drive line connecting portion of the capacitor is connected, FIG. 4B showing a variation of a voltage across the output line in a portion to which the output line connecting portion of the capacitor is connected, and FIG. 4C showing a variation of a voltage across the output line between the smoothing circuit and the display control MPU;

FIG. 5 is a view used to describe an advantage achieved by providing a step-down portion to the power supply circuit;

FIG. 6 is a circuit diagram showing, as a modification of the configuration of FIG. 2, a configuration of a power supply circuit according to a second embodiment; and

FIGS. 7A to 7C are views each showing an operation of the power supply circuit according to the second embodiment, FIG. 7A showing switching of an FET between an ON state and an OFF state, FIG. 7B showing switching of a step-down switch between an ON state and an OFF state, and FIG. 7C showing switching of a regulation switch between an ON state and an OFF state.

### DETAILED DESCRIPTION

### First Embodiment

In the respective embodiments below, a description may not be repeated by labeling same reference numerals to equivalent components. In a case where only a part of the configuration is described in the respective embodiments, the configuration described earlier in the other embodiments can be applied to the rest of the configuration. Besides combinations of configurations explicitly shown in the descriptions of the respective embodiments, partial combinations of configurations in two or more embodiments not explicitly shown are also possible unless a problem arises from such combinations.

### First Embodiment

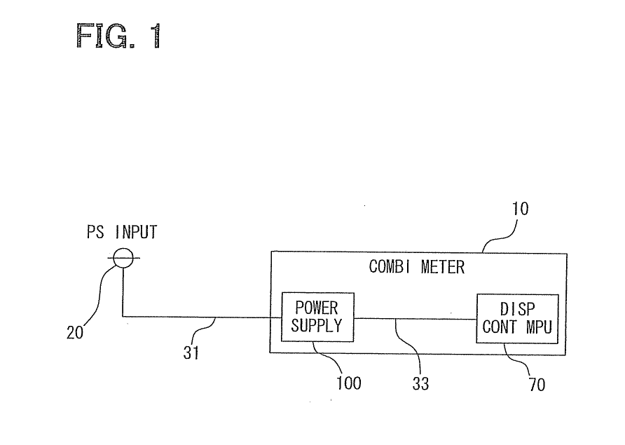

FIG. 1 is a view schematically showing a configuration of a combination meter 10 provided with a power supply circuit 100 according to a first embodiment. The combination meter 10 includes the power supply circuit 100 and a display control MPU (Micro-Processing Unit) 70 connected to the power supply circuit 100 via an output line 33.

The power supply circuit 100 is connected to a power supply input portion 20 via a power supply line 31. Power is supplied to the power supply input portion 20 from an outside power supply portion of the combination meter 10, such as an in-vehicle battery. The power supply circuit 100 generates power corresponding to a load condition of the display control MPU 70 using power supplied therein via the power supply input portion 20 and through the power supply line 31. The power supply circuit 100 outputs the power generated therein to the display control MPU 70 through the output line 33.

The display control MPU 70 is a load portion that consumes power supplied therein from the power circuit 100. The display control MPU 70 acquires vehicle information outputted from various in-vehicle control devices via a vehicle communication network. The display control MPU 70 then performs various operations involved in a display by the combination meter 10 to display the acquired vehicle information to a vehicle user.

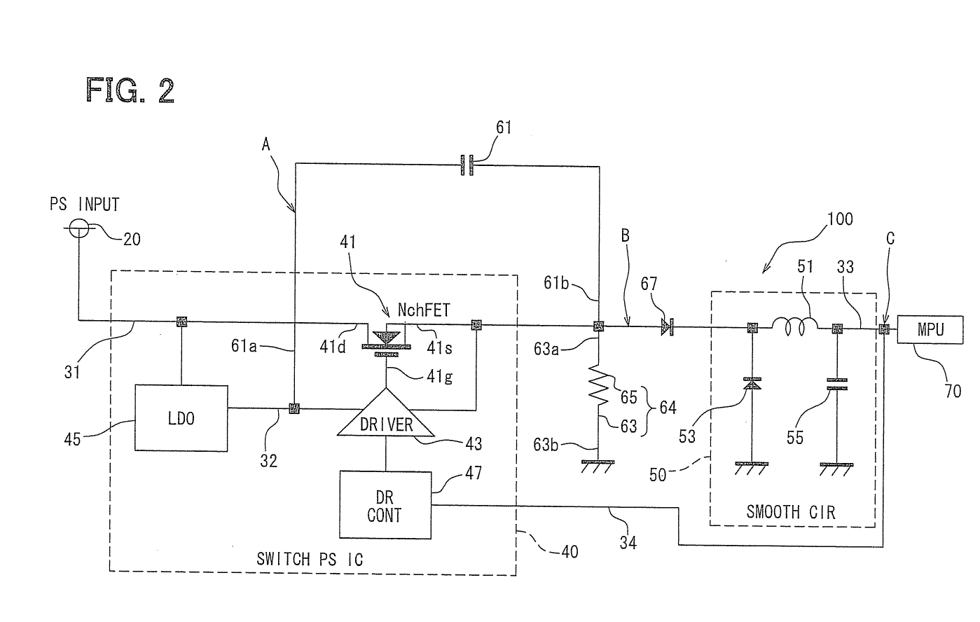

FIG. 2 is a circuit diagram showing a configuration of the power supply circuit 100. The power supply circuit 100 includes a switching power supply IC 40, a capacitor 61, and a smoothing circuit 50. The switching power supply IC 40 has an FET (Field Effect Transistor) 41, a driver 43, an LDO (Low Drop Out) regulator 45, and a driver control portion 47.

The FET 41 is an N-type MOS (Metal-Oxide-Semiconductor) FET. The FET 41 operates as a switching element that applies pulse width modulation control to power outputted from the power supply circuit 100. The FET 41 has a drain 41d, a source 41s, and a gate 41g. The drain 41d is connected to the power supply line 31. The drain 41d is supplied with power from a battery or the like through the power supply line 31. The source 41s is connected to the output line 33. The display control MPU 70 is supplied with power from the source 41s through the output line 33. The gate 41g is connected to a drive line 32 branched from the power supply line 31 in the switching power supply IC 40. The gate 41g is supplied with power from a battery or the like through the drive line 32. In the FET 41, when a voltage with potential higher than potential at the source 41s is applied to the gate 41g, conduction between the drain 41d and the source 41s is switched to an ON state.

The driver 43 is provided to the drive line 32. The driver 43 is connected to the driver control portion 47. The driver 43 switches conduction between the drain 41d and the source 41s of the FET 41 from an OFF state to an ON state by applying a voltage to the gate 41g of the FET 41 according to a command from the driver control portion 47. More specifically, when the driver 43 applies a voltage with potential higher than potential at the source 41s to the gate 41g, conduction between the drain 41d and the source 41s of the FET 41 is switched to an ON state.

The LDO regulator 45 is provided to the drive line 32 between one end portion connected to the power supply line 31 and the driver 43. The LDO regulator 45 transforms a voltage of power supplied therein via the power supply input portion 20 and through the power supply line 31 to a pre-set designated voltage and supplies the transformed voltage to the driver 43.

The driver control portion 47 is connected to the output line 33 via a monitoring line 34. The monitoring line 34 is connected to the output line 33 between the smoothing circuit 50 and the display control MPU 70. The driver control portion 47 monitors a load condition of the display control MPU 70 by detecting a voltage across the output line 33 between the smoothing circuit 50 and the display control MPU 70 via the monitoring line 34. The driver control portion 47 determines a ratio of times during which conduction of the FET 41 is in an ON state and an OFF state, a so-called ON duty ratio, according to a load condition of the display control MPU 70. On the basis of the ON duty ratio thus determined, the driver control portion 47 controls switching of conduction of the FET 41 between an ON state and an OFF state by the driver 43.

The capacitor 61 is a power receiving element having a predetermined electrostatic capacity and capable of accumulating and discharging charges. The capacitor 61 can be charged with power by accumulating charges corresponding to a potential difference across the capacitor 61. Of the both end portions of the capacitor 61, one end portion is a drive line connecting portion 61a. The drive line connecting portion 61a is connected to the drive line 32 in a portion between the LDO regulator 45 and the driver 43. Of the both end portions of the capacitor 61, the other end portion is an output line connecting portion 61b. The output line connecting portion 61b is connected to the output line 33 in a portion between the switching power supply IC 40 and the smoothing circuit 50. Owing to this connection configuration, the capacitor 61 is charged with power due to a potential difference between the drive line 32 and the output line 33.

The smoothing circuit 50 is provided to the output line 33. The smoothing circuit 50 rectifies and smoothens a variation of a square-wave voltage of power outputted from the switching power supply IC 40. The smoothing circuit 50 has an inductor 51, a diode 53, and a capacitor 55. The inductor 51 is provided to the output line 33. The diode 53 is provided to a wire connecting the output line 33 in a portion on the side of the switching power supply IC 40 of the inductor 51 to the ground. The capacitor 55 is provided to a wire connecting the output line 33 in a portion on the side of the display control MPU 70 of the inductor 51 to the ground. As the inductor 51, the diode 53, and the capacitor 55 operate in cooperation, the smoothing circuit 50 lowers a voltage of power outputted from the switching power supply IC 40 to a preliminarily specified voltage (about 5 V) to stabilize the voltage and outputs the stabilized voltage to the display control MPU 70.

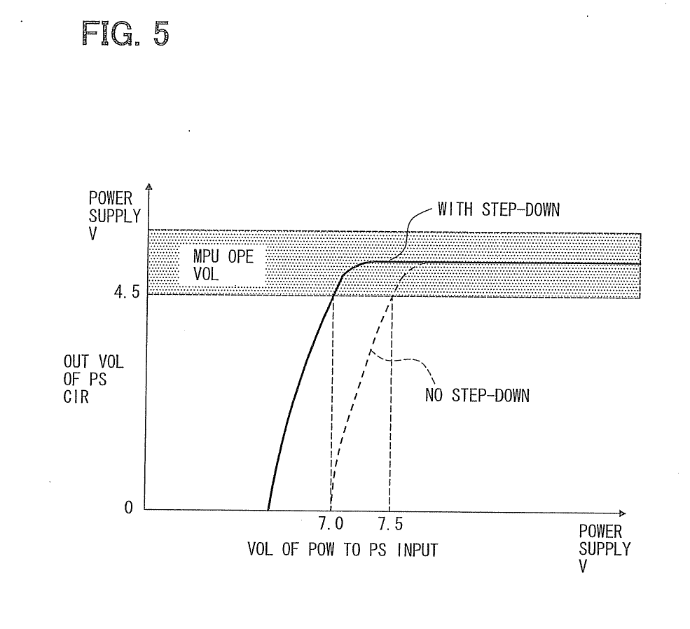

The power supply circuit 100 described thus far changes an operation to output power in response to a load condition of the display control MPU 70. Accordingly, a voltage (for example, 4.5 V or higher, see FIG. 5) with which the display control MPU 70 is operable is maintained in power outputted from the power supply circuit 100 to the display control MPU 70. More specifically, in a case where the display control MPU 70 is in a high load condition, the power supply circuit 100 outputs power to the display control MPU 70 by operating in a normal load mode. In the normal load mode, a current supplied from the power supply circuit 100 to the display control MPU 70 is in the order of several ten milliamperes to several amperes. The power supply circuit 100 operates in the normal load mode when an accessory (ACC) power supply of the vehicle is switched to an ON state by an operation of the driver.

On the contrary, in a case where the display control MPU 70 is in a light load condition, the power supply circuit 100 outputs power to the display control MPU 70 by operating in a light load mode. In the light load mode, a current supplied from the power supply circuit 100 to the display control MPU 70 is in the order of several ten microamperes to several hundred microamperes. The power supply circuit 100 operates in the light load mode when the ACC power supply of the vehicle is switched to an OFF state by an operation of the driver.

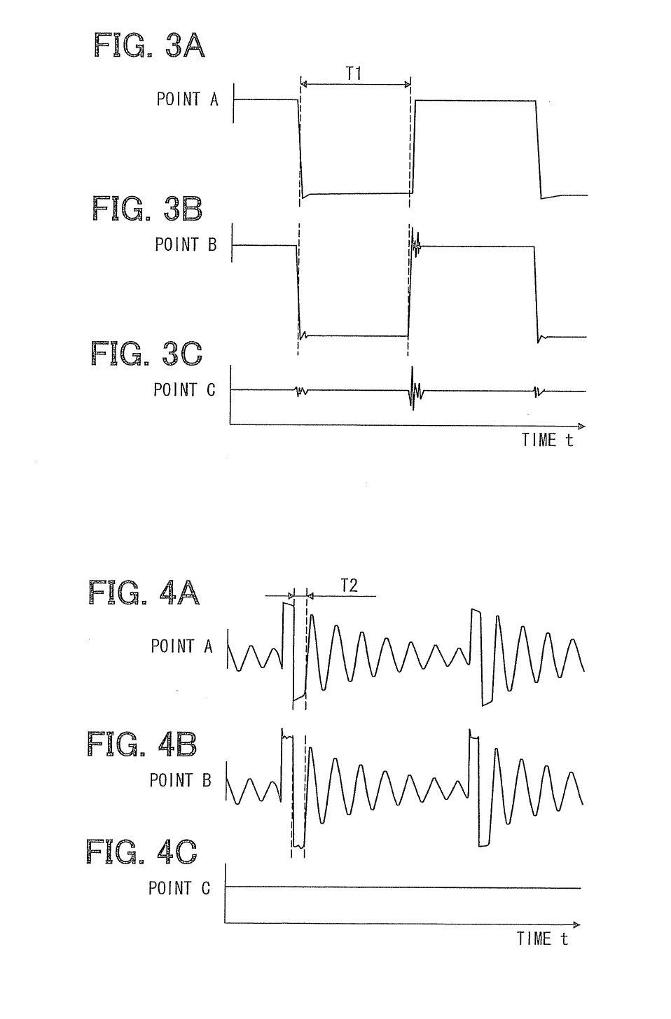

An operation of the power supply circuit 100 in the normal load mode will be described first in accordance with FIG. 2 and FIGS. 3A to 3C. FIG. 3A shows a variation of a voltage at a point A of FIG. 2. FIG. 3B shows a variation of a voltage at a point B of FIG. 2. FIG. 3C shows a variation of a voltage at a point C of FIG. 2. In the normal load mode, the power supply circuit 100 adjusts an amount of power to be supplied to the display control MPU 70 by pulse width modulation control. To this end, the driver control portion 47 determines an ON duty ratio of the FET 41 by monitoring a load condition of the display control MPU 70.

During the pulse width modulation control, the capacitor 61 is charged with power when conduction between the drain 41d and the source 41s of the FET 41 is in an OFF state (see T1 of FIGS. 3A to 3C). When conduction of the FET 41 is in an OFF state, because power in the output line 33 is consumed by the display control MPU 70, a voltage across the output line 33 (see point B of FIG. 3B) drops below a voltage at the point A of the drive line connecting portion 61a (see FIG. 3A). Hence, the capacitor 61 can be charged with power due to a potential difference between the drive line connecting portion 61a and the output line connecting portion 61b. According to a command from the driver control portion 47, the driver 43 switches conduction of the FET 41 to an ON state by applying a voltage with potential higher than potential at the source 41s to the gate 41g using power supplied therein through the drive line 32 and power charged to the capacitor 61. Also, according to a command from the driver control portion 47, the driver 43 switches conduction of the FET 41 to an OFF state by stopping voltage application to the gate 41g. As the operation described above is repeated, it becomes possible to maintain a voltage across the output line 33 in a portion (point C) between the smoothing circuit 50 and the display control MPU 70 in the vicinity of a pre-set value (see FIG. 3C).

An operation of the power supply circuit 100 in the light load mode will now be described in accordance with FIG. 2 and FIGS. 4A to 4C. FIG. 4A shows a variation of a voltage at the point A of FIG. 2. FIG. 4B shows a variation of a voltage at the point B of FIG. 2. FIG. 4C shows a variation of a voltage at the point C of FIG. 2.

In the light load mode, the power supply circuit 100 adjusts an amount of power to be supplied to the display control MPU 70 by hysteresis control. To this end, the driver control portion 47 detects a voltage across the output line 33 between the smoothing circuit 50 and the display control MPU 70 via the monitoring line 34. When a voltage across the output line 33 detected via the monitoring line 34 drops below a pre-set lower limit threshold, the driver control portion 47 controls the driver 43 to switch conduction between the drain 41d and the source 41s of the FET 41 to an ON state. This operation allows the voltage across the output line 33 to restore. The voltage across the output line 33 detected via the monitoring line 34 eventually restores to a pre-set upper limit threshold, and on the basis of this restoration the driver control portion 47 controls the driver 43 to switch conduction between the drain 41d and the source 41s of the FET 41 to an OFF state. As the operation described above is repeated, power corresponding to a light load condition of the display control MPU 70 is outputted continuously. It thus becomes possible to maintain a voltage across the output line 33 in a portion (point C) between the smoothing circuit 50 and the display control MPU 70 in the vicinity of a preliminarily specified value (see FIG. 4C).

When a preliminarily specified time has elapsed since conduction of the FET 41 was switched to an ON state, the driver control portion 47 may control the driver 43 to switch conduction between the drain 41d and the source 41s of the FET 41 to an OFF state. It should be noted that a variation of the voltage across the output line 33 detected by the driver control portion 47 is negligibly small and is therefore not shown in FIG. 4C.

Even during the hysteresis control as described above, it is necessary to charge the capacitor 61 with power when conduction between the drain 41d and the source 41s of the FET 41 is in an OFF state. However, power consumed by the display control MPU 70 during an operation in the light load mode is so small that a voltage across the output line 33 hardly drops. Accordingly, for example, a fluctuation of a voltage occurring in the output line 33 from the switching between an ON state and an OFF state of conduction of the FET 41 is used when the capacitor 61 is charged. After conduction is switched to an OFF state, a voltage across the output line 33 (see point B of FIG. 4B) drops and temporarily falls below the voltage at the point A of the drive line connecting portion 61a (see FIG. 4A). The capacitor 61 is charged with power due to a voltage difference between the output line 33 and the drive line 32 in this time during which a voltage across the output line 33 temporarily drops (see T2 of FIGS. 4A to 4C). The driver 43 thus becomes able to switch conduction of the FEY 41 to an ON state according to a command from the driver control portion 47.

(Characteristic Portion)

A characteristic portion of the power supply circuit 100 will now be described. The power supply circuit 100 further includes a step-down portion 64 and a diode 67.

The step-down portion 64 has a ground line 63 and a resistor 65. Of the both end portions of the ground line 63, one end portion is an output line connecting portion 63a. The output line connecting portion 63a is connected to the output line 33 in a portion between the switching power supply IC 40 and the smoothing circuit 50. Of the both end portions of the ground line 63, the other end portion is a ground portion 63b. The ground portion 63b is grounded. The resistor 65 is a passive element having a predetermined electrical resistance value and provided to the ground line 63. The step-down portion 64 configured as above exerts a function of lowering a voltage across the output line 33 when conduction of the FET 41 is in an OFF state.

The diode 67 is provided to the output line 33 on a side closer to the smoothing circuit 50 and the display control MPU 70 than a portion to which the ground line 63 and the capacitor 61 are connected. The diode 67 allows a flow of a current from the source 41s of FET 41 toward the display control MPU 70. On the other hand, the diode 67 regulates a flow of a current from the display control MPU 70 through the output line 33 toward a portion to which the ground line 63 is connected. Owing to the configuration as above, when a voltage across the output line 33 is lowered by the step-down portion 64, the diode 67 suppresses a backflow of a current from the smoothing circuit 50 toward the FET 41.

In a power supply circuit that is not provided with the step-down portion 64 as described above, in a case where a voltage of power supplied from the power supply input portion 20 drops, an output of power to the display control MPU 70 is interrupted as is shown in FIG. 5. The reason why will be described below.

In a low load condition in which an amount of power consumed by the display control MPU 70 is small, even when conduction of the FET 41 is in an OFF state, a voltage across the output line 33 hardly drops. Further, when a voltage of power supplied from the battery or the like to the power supply input portion 20 drops in this instance for some reason, a voltage supplied to the drive line 32 drops, too. The LDO regulator 45 therefore can no longer output power to the driver 43. It thus becomes impossible to secure a potential difference between the drive line 32 and the output line 33. Accordingly, because the capacitor 61 cannot be charged with power, the driver 43 fails to switch conduction of the FET 41 to an ON state. The power supply circuit 100 thus becomes unable to output power to the display control MPU 70 from the source 41s.

In contrast, in the power supply circuit 100 of the first embodiment provided with the step-down portion 64, when conduction of the FET 41 is in an OFF state, the step-down portion 64 lowers a voltage across the output line 33 in a portion to which the output line connecting portion 61b of the capacitor 61 is connected. Owing to the step-down function of the step-down portion 64 as above, even in a case where the display control MPU 70 is in a light load condition and a voltage across the drive line 32 drops with a voltage drop in power supplied to the power supply input portion 20, it becomes possible to secure a potential difference between the drive line 32 and the output line 33. Hence, when conduction of the FET 41 is in an OFF state, the capacitor 61 can be charged with power due to a potential difference between the drive line 32 and the output line 33. The driver 43 can therefore switch conduction between the drain 41d and the source 41s to an ON state by adding power charged to the capacitor 61 to power supplied therein from the LDO regulator 45 and thereby applying a voltage with potential higher than potential at the source 41s to the gate 41g of FET 41.

In addition, even when the step-down portion 64 is lowering a voltage across the output line 33, a flow of a current from the display control MPU 70 toward the ground line 63 is regulated by the diode 67. Hence, power outputted from the source 41s to the display control MPU 70 through the output line 33 when conduction of the FET 41 is in an ON state can be supplied to the display control MPU 70 without being returned to the portion in which a voltage is lowered by the function of the step-down portion 64.

Accordingly, even in a case where a voltage of power supplied via the power input portion 20 drops when the display control MPU 70 is in a light load condition, the power supply circuit 100 can continuously output power corresponding to a load condition of the display control MPU 70 (see FIG. 5).

In addition, according to the first embodiment, when conduction of the FET 41 is in an OFF state, a current flows from the output line connecting portion 63a to the ground portion 63b of the ground line 63 connected to the output line 33. Accordingly, even in a case where a voltage of power supplied to the drive line 32 drops, the step-down portion 64 can generate a potential difference between the output line 33 and the drive line 32 by lowering a voltage across the output line 33 in a reliable manner. Owing to the configuration above, the capacitor 61 can be charged. Hence, the driver 43 can switch conduction between the drain 41d and the source 41s to an ON state by adding power charged to the capacitor 61 to power supplied therein through the drive line 32.

Also, the resistor 65 provided to the ground line 63 can prevent a short circuit of the output line 33 occurring when the ground line 63 is connected thereto. Hence, when conduction of the FET 41 is in an ON state, power can be outputted in a reliable manner from the source 41s to the display control MPU 70 through the output line 33.

According to the first embodiment, when conduction of the FET 41 is in an ON state, the diode 67 allows a flow of a current from the source 41s toward the display control MPU 70. Hence, when conduction of the FET 41 is in an ON state, power can be outputted in a reliable manner from the source 41s to the display control MPU 70 through the output line 33. On the other hand, a flow of a current through the output line 33 from the display control MPU 70 toward the ground line 63 is regulated by the diode 67. Hence, power outputted from the source 41s to the display control MPU 70 when conduction of the FET 41 is in an ON state can be supplied to the display control portion MPU 70 in a reliable manner without being returned to the step-down portion 64 when conduction is switched to an OFF state.

As has been described, the power supply circuit 100 not only lowers a voltage across the output line 33 by means of the step-down portion 64 but also regulates a backflow of a current by means of the diode 67. The power supply circuit 100 can therefore continuously output power corresponding to a load condition of the display control MPU 70 while maintaining a simple configuration.

According to the first embodiment, in a case where power outputted under the hysteresis control is controlled, the step-down portion 64 exerts the function of securing a potential difference between the drive line 32 and the output line 33 by lowering a voltage across the output line 33. Accordingly, because the capacitor 61 can be charged, the driver 43 becomes able to switch conduction of the FET 41 to an ON state in a reliable manner by adding power supplied therein from the battery or the like through the drive line 32 to power charged to the capacitor 61. As has been described above, by combining the driver 43 performing hysteresis control and the step-down portion 64 lowering a voltage across the output line 33, it becomes possible to achieve the power supply circuit 100 capable of continuously outputting power corresponding to a light load condition of the display control MPU 70 in a reliable manner.

In the first embodiment, it should be appreciated that the battery is the equivalent of “a power supply portion” referred to in the appended claims, the FET 41 is the equivalent of “an N-type field effect transistor” referred to in the appended claims, the driver 43 is the equivalent of “drive means” referred to in the appended claims, the capacitor 61 is the equivalent of “charge means” referred to in the appended claims, the drive line connecting portion 61a is the equivalent of “ one end portion” of the drive means referred to in the appended claims, the output line connecting portion 61b is the equivalent of “the other end portion” of the drive means referred to in the appended claims, the step-down portion 64 is the equivalent of “step-down means” referred to in the appended claims, the resistor 65 is the equivalent of “an electrical resistor portion” referred to in the appended claims, the output line connecting portion 63a is the equivalent of “one end portion” of a ground line referred to in the appended claims, the ground portion 63b is the equivalent of “the other end portion” of the ground line referred to in the appended claims, the diode 67 is the equivalent of “current regulation means” referred to in the appended claims, and the display control MPU 70 is the equivalent of “a load portion” referred to in the appended claims.

### Second Embodiment

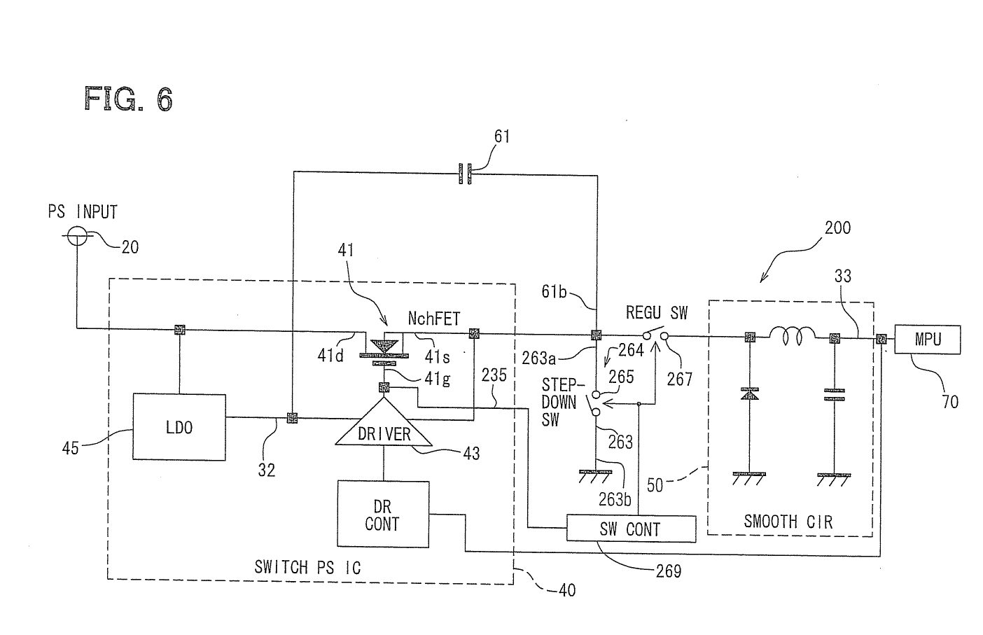

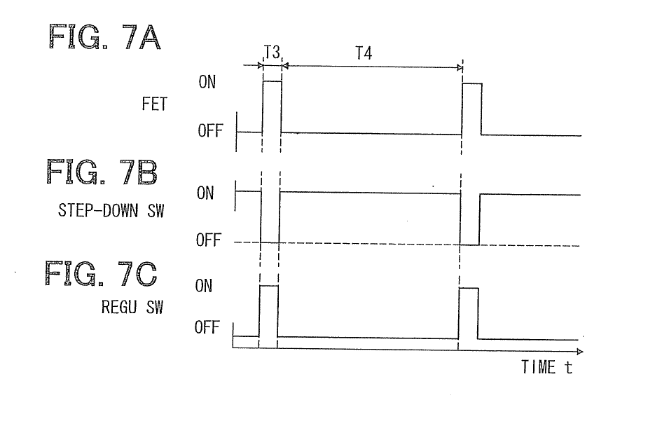

A second embodiment shown in FIG. 6 and FIGS. 7A to 7C is a modification of the first embodiment above. A power supply circuit 200 of the second embodiment has a step-down switch 265 instead of the resistor 65 (see FIG. 2) of the first embodiment above. In addition, the power supply circuit 200 has a regulation switch 267 instead of the diode 67 (see FIG. 2) of the first embodiment above. Further, the power supply circuit 200 has a switch control portion 269 controlling the step-down switch 265 and the regulation switch 267. Hereinafter, the power supply circuit 200 of the second embodiment will be described in detail in accordance with FIG. 6.

The step-down portion 264 of the second embodiment is formed of a ground line 263 substantially the same as the ground line 63 (see FIG. 2) of the first embodiment above and the step-down switch 265 and the switch control portion 269 described above.

The step-down switch 265 is provided to the ground line 263 and switches conduction of the ground line 263 between an ON state and an OFF state. The step-down switch 265 is a switching element, for example, an NPN junction bipolar transistor. A collector of the step-down switch 265 is connected to the output line 33 via an output line connecting portion 263a. A base of the step-down switch 265 is connected to the switch control portion 269. An emitter of the step-down switch 265 is connected to the ground via a grounding portion 263b.

The switch control portion 269 is connected to the drive line 32 between the driver 43 and the gate 41g of the FET 41 via a drive signal detection line 235. The switch control portion 269 detects an ON state and an OFF state of conduction of the FET 41 via the drive signal detection line 235. As the switch control portion 269 applies a current to the base of the step-down switch 265, the collector and the emitter of the step-down switch 265 are brought into a conducting state.

The regulation switch 267 is provided to the output line 33 and switches conduction of the output line 33 between an ON state and an OFF state. The regulation switch 267 is a switching element, for example, an NPN junction bipolar transistor. A collector of the step-down switch regulation switch 267 is connected to the switching power supply IC 40 via the output line 33. A base of the regulation switch 267 is connected to the switch control portion 269. An emitter of the regulation switch 267 is connected to the smoothing circuit 50 via the output line 33.

As is shown in FIGS. 7A to 7C, when conduction of the FET 41 is in an OFF state (see T4 of FIGS. 7A to 7C), the switch control portion 269 applies a current allowing conduction between the collector and the emitter to the base, so that the step-down switch 265 is switched to an ON state (see FIG. 7B). Owing to this configuration, the step-down portion 264 exerts a function of lowering a voltage across the output line 33 when conduction of the FET 41 is in an OFF state. On the other hand, the switch control portion 269 controls the step-down switch 265 to switch to an OFF state by stopping application of the current to the base when conduction of the FET 41 is in an ON state (see T3 of FIGS. 7A to 7C).

In addition, when conduction of the FET 41 is in an ON state (see T3 of FIGS. 7A to 7C), the switch control portion 269 applies a current allowing conduction between the collector and the emitter to the base (see FIG. 7C), so that the regulation switch 267 is switched to an ON state. On the other hand, when conduction of the FET 41 is in an OFF state (see T4 of FIGS. 7A to 7C), the switch control portion 269 controls the regulation switch 267 to switch to an OFF state by stopping application of the current to the base. Owing to this configuration, the regulation switch 267 and the switch control portion 269 cooperate to exert a function of regulating a flow of a current from the display control MPU 70 and the smoothing circuit 50 toward the step-down portion 264.

According to the second embodiment described thus far, too, when conduction of the FET 41 is in an OFF state, the step-down portion 264 lowers a voltage across the output line 33 in a portion to which the output line connecting portion 61b of the capacitor 61 is connected. Owing to this step-down function of the step-down portion 264, even in a case where the display control MPU 70 is in a light load condition and a voltage across the drive line 32 drops with a voltage drop in power supplied to the power supply input portion 20, a potential difference between the drive line 32 and the output line 33 can be secured. Hence, when conduction of the FET 41 is in an OFF state, the capacitor 61 can be charged with power due to a potential difference between the drive line 32 and the output line 33. Accordingly, the driver 43 can switch conduction between the drain 41d and the source 41s to an ON state by adding power charged to the capacitor 61 to power supplied therein from the LDO regulator 45 and thereby applying a voltage with potential higher than potential at the source 41s to the gate 41g of the FET 41.

In addition, even when the step-down portion 264 is lowering a voltage across the output line 33, a flow of a current from the display control MPU 70 toward the ground line 263 is regulated by the regulation switch 267. Hence, power outputted from the source 41s to the display control MPU 70 through the output line 33 when conduction of the FET 41 is an ON state can be supplied to the display control MPU 70 in a reliable manner without being returned to the portion in which the voltage is lowered by the step-down function of the step-down portion 264. Accordingly, even in a case where a voltage of power supplied via the power supply input portion 20 drops when the display control MPU 70 is in a light load condition, the power supply circuit 200 can continuously output power corresponding to a load condition of the display control MPU 70.

In addition, according to the second embodiment, as the switch control portion 269 controls the step-down switch 265 to switch to an ON state when conduction of the FET 41 is in an OFF state, a current flows to the ground portion 263b from the output line connecting portion 263a connected to the output line 33. Hence, even in a case where a voltage of power supplied to the drive line 32 drops, the step-down portion 264 can generate a potential difference between the output line 33 and the drive line 32 by lowering a voltage across the output line 33 in a reliable manner. Accordingly, because the capacitor 61 can be charged, the driver 43 can switch conduction between the drain 41d and the source 41s to an ON state by adding power charged to the capacitor 61 to power supplied therein through the drive line 32.

Further, the switch control portion 269 makes the ground line 263 non-conductive by controlling the regulation switch 267 to switch to an OFF state when conduction of the FET 41 is in an ON state. Hence, when condition of the FET 41 is in an ON state, power can be outputted from the source 41s to the display control MPU 70 through the output line 33 in a reliable manner without being outputted to the ground line 263.

Also, according to the second embodiment, the switch control portion 269 controls the regulation switch 267 to switch to an ON state when conduction of the FET 41 is in an ON state. Hence, when conduction of the FET 41 is in an ON state, power can be outputted from the source 41s to the display control MPU 70 through the output line 33 in a reliable manner. On the other hand, the step-down portion 264 lowers a voltage across the output line 33 when conduction of the FET 41 is in an OFF state. In this instance, as the switch control portion 269 controls the regulation switch 267 to switch to an OFF state, the regulation switch 267 regulates a flow of a current through the output line 33 toward a portion to which the ground line 263 is connected. Owing to the configuration above, power outputted from the source 41s to the display control MPU 70 when conduction of the FET 41 is in an ON state can be supplied to the display control portion MPU 70 without being returned to the step-down portion 264 when conduction is switched to an OFF state.

As has been described, even in a case where a voltage of power supplied when the display control MPU 70 is in a light load condition, the power supply circuit 200 can continuously output power corresponding to a load condition of the display control MPU 70 in a reliable manner.

In the second embodiment, it should be appreciated that the step-down portion 264 is the equivalent of “step-down means” referred to in the appended claims, the step-down switch 265 is the equivalent of “a step-down switch portion” referred to in the appended claims, the regulation switch 267 is the equivalent of “a regulation switch portion” referred to in the appended claims, the switch control portion 269 is the equivalent of “a step-down switch control portion” and “a regulation switch control portion” referred to in the appended claims, the output line connection portion 263a is the equivalent of “one end portion” of a ground line referred to in the appended claims, the ground portion 263b is the equivalent of “the other end portion” of the ground line referred to in the appended claims, and the regulation switch 267 and the switch control portion 269 are the equivalent of “current regulation means” referred to in the appended claims.

### Other Embodiments

In the embodiments above, each of the power supply circuit 100 and the power supply circuit 200 is provided with a MOSFET as an N-type field effect transistor. It should be appreciated, however, that the field effect transistor is not limited to a MOSFET. The power circuit may be provided, for example, with a junction FET or a metal semiconductor FET as a replacement for a MOSFET. Further, as long as a transistor is capable of switching conduction between an ON state and an OFF state with an application of a voltage, for example, an IGBT (Insulated Gate Bipolar Transistor) may be provided to the power supply circuit. In a configuration in which an IGBT is provided, the emitter is the equivalent of the source.

In the second embodiment above, an NPN junction bipolar transistor is used as the step-down switch and the regulation switch portion. It should be appreciated, however, that a configuration used as the step-down switch portion and the regulation switch portion is not limited to a bipolar transistor and any switching element is available as long as it is capable of switching conduction of the ground line and the output line between an ON state and an OFF state. For example, a field effect transistor like the FET 41 may be provided to each of the ground line and the output line as the step-down switch portion and the regulation switch portion, respectively.

In the second embodiment above, the switch control portion 269 controls both the step-down switch 265 and the regulation switch 267 as a step-down switch control portion and also as a regulation switch control portion. It should be noted, however, that a control circuit corresponding to the step-down switch control portion and a control circuit corresponding to the regulation switch control portion may be provided separately. When configured in this manner, a control method is not particularly limited as long as conduction states of the step-down switch portion and the regulation switch portion are mutually exclusive. For example, control may be performed in such a manner that the regulation switch control portion controls the regulation switch portion to switch to an OFF state when the step-down switch portion is in an ON state upon detection of conduction in the ground line and controls the regulation switch portion to switch to an ON state when the step-down switch portion is in an OFF state.

In the embodiments above, the step-down portion is a configuration to lower a voltage across the output line to which the capacitor is connected when power outputted to the display control MPU is adjusted by hysteresis control. It should be noted, however, that the step-portion can exert the step-down function of lowering a voltage across the output line even when power outputted to the display control MPU is adjusted by pulse width modulation control.

In the first embodiment above, an electrical resistance value of the resistor provided to the ground line can be adjusted as needed. When the electrical resistance value of the resistor is increased, a dark current that flows to the ground line while the FET is conducting decreases. Conversely, when the electrical resistance value of the resistor is reduced, a current flowing to the ground line increases. Hence, the step-down function of the step-down portion can be exerted in a more reliable manner.

In the second embodiment above, the step-down switch alone is provided to the ground line. It should be appreciated, however, that a resistor may be also provided to the ground line. Also, in the embodiments above, the diode and the regulation switch are provided to the output line as a configuration to regulate a backflow of a current. It should be appreciated, however, that a configuration other than the diode and the regulation switch may be provided as current regulation means as long as the output line can be divided to a portion to which the capacitor is connected and a portion in which the smoothing circuit is provided.

While the example is applied to a power supply circuit in a combination meter, it should be appreciated, however, that examples are not limited to the power supply circuit in the combination meter. The example is also applicable to a power supply circuit incorporated into various types of apparatus and generating power corresponding to a load condition of a load portion out of power inputted therein.

The above disclosure has the following aspects.

According to an example aspect of the present disclosure, a power supply circuit includes: an N-type field effect transistor for outputting electricity to a load via a source of the transistor, the electricity supplied from an external power supply via a drain of the transistor, wherein the transistor controls conduction between the drain and the source to switch between an on-state and an off-state so that the transistor controls the electricity to be output via the source according to a load condition of the load; a drive line for supplying the electricity from the external power supply to a gate of the transistor; an output line for outputting the electricity from the source to the load; a charge device for charging the electricity therein according to a potential difference between the drive line and the output line, wherein the charge device includes one end connecting to the drive line and the other end connecting to the output line; a drive device disposed in the drive line, wherein the drive device applies a voltage to the gate higher than a voltage of the source with using the electricity supplied from the external power supply and the electricity charged in the charge device so that the transistor switches the conduction to be the on-state; a step-down device connected to the output line, wherein the step-down device reduces a voltage across the output line when the conduction of the transistor is in the off-state; and a current regulation device disposed in the output line on a load side from both of a connection between the step-down device and the output line and a connection between the charge device and the output line, wherein the current regulation device regulates a flow of current from the load toward the step-down device.

According to the above circuit, when conduction of the N-type field effect transistor is in an OFF state, the step-down device connected to the output line through which to output power from the source to the load lowers a voltage across the output line in the portion to which the step-down device and the charge device are connected. Hence, even in a case where the load is in a light load condition and a voltage across the drive line through which to supply power to the gate of the N-type field effect transistor drops with a voltage drop in power supplied from the external power supply, a potential difference between the drive line and the output line can be secured. Consequently, the charge device can be charged with power due to a potential difference between the drive line and the output line. The drive device provided to the drive line thus becomes able to switch conduction between the drain and the source to an ON state by adding power charged to the charge device to power supplied therein from the outside and thereby applying a voltage with potential higher than potential at the source to the gate of the N-type field effect transistor.

In addition, even when the step-down device is lowering a voltage across the output line, a flow of a current from the load toward the step-down device is regulated by the current regulation device provided to the output line on a side closer to the load than a portion to which the step-down device and the charge device are connected. Hence, power outputted from the source to the load through the output line when conduction of the N-type field effect transistor is in an ON state can be supplied to the load in a reliable manner without being returned through the output line to a portion in which a voltage is lowered by the step-down function of the step-down device.

Hence, even in a case where a voltage across the external power supply drops when the load is in a light load condition, the power supply circuit can continuously output power corresponding to a load condition of the load.

Alternatively, the step-down device may include: a ground line having one end connected to the output line and the other end connected to a ground; and an electric resistor disposed in the ground line. In this case, when conduction of the N-type field effect transistor is in an OFF state, a current flows from one end of the ground line connected to the output line to the grounded other end of the ground line. Hence, even in a case where a voltage of power supplied to the drive line drops, the step-down device can generate a potential difference between the output line and the drive line by lowering a voltage across the output line to which the one end of the ground line is connected in a reliable manner. Accordingly, because the charge device can be charged, the drive device becomes able to switch conduction between the drain and the source to an ON state by adding power charged to the charge device to power supplied therein through the drive line. Further, the electrical resistor provided to the ground line can prevent a short circuit of the output line occurring when the ground line is connected thereto. Hence, when conduction of the N-type field effect transistor is in an ON state, power can be outputted from the source to the load through the output line in a reliable manner. The power supply circuit provided with the step-down device as above can be of a simple configuration and can yet continuously output power corresponding to a load condition of the load even in a case where a voltage across the external power supply drops when the load is in a light load condition.

Alternatively, the step-down device may include: a ground line having one end connected to the output line and the other end connected to a ground; a step-down switch disposed in the ground line and switching conduction of the ground line between an on-state and an off-state; and a step-down switch controller controlling the step-down switch to be the on-state when the conduction of the transistor is in the off-state. In this case, when conduction of the N-type field effect transistor is in an OFF state, the step-down switch controller controls the step-down switch to switch to an ON state. Then, current flows from one end of the ground line connected to the output line to the grounded other end of the ground line. Hence, even in a case where a voltage of power supplied to the drive line drops, the step-down device can generate a potential difference between the output line and the drive line by lowering a voltage across the output line to which one end of the ground line is connected in a reliable manner. Owing to the configuration above, because the charge device can be charged, the drive device becomes able to switch conduction between the drain and the source to an ON state by adding power charged to the charge device to power supplied through the drive line. Further, when conduction of the N-type field effect transistor is in an ON state, the step-down switch controller makes the ground line non-conductive by controlling the step-down switch to switch to an OFF state. Hence, when conduction of the N-type field effect transistor is in an ON state, power can be outputted from the source to the load through the output line in a reliable manner without being outputted to the ground line. The power supply circuit having the step-down switch and the step-down switch controller configured as above in the step-down device can continuously output power corresponding to a load condition of the load even in a case where a voltage across the external power supply drops when the load is in a light load condition.

Alternatively, the current regulation device may include a diode disposed in the output line. The diode allows a flow of current from the source toward the load, and the diode restricts a flow of current from the load toward the connection between the step-down device and the output line. In this case, the diode allows a flow of a current from the source toward the load when conduction of the N-type field effect transistor is in an ON state. Hence, when conduction is in an ON state, power can be outputted from the source to the load through the output line in a reliable manner. On the other hand, when conduction of the N-type field effect transistor is in an OFF state, the step-down device lowers a voltage across the output line. A current therefore starts to flow through the output line toward a portion to which the step-down device is connected. However, a flow of a current through the output line from the load toward the step-down device is regulated by the diode. When configured in this manner, power outputted from the source to the load when conduction of the N-type field effect transistor is an ON state can be supplied to the load in a reliable manner without being returned to the step-down device when conduction is switched to an OFF state. Hence, the power supply circuit having the diode in the current regulation device can continuously output power corresponding to a load condition of the load while maintaining a simple configuration.

Alternatively, the current regulation device may include: a regulation switch disposed in the output line and switching conduction of the output line between an on-state and an off-state; and a regulation switch controller regulating a flow of current from the load toward the step-down device by controlling the regulation switch to be the off-state when the conduction of the transistor is in the off-state. In this case, when conduction of the N-type field effect transistor is in an ON state, the regulation switch controller controls the regulation switch to switch to an ON state. Hence, when conduction is in an ON state, power can be outputted from the source to the load through the output line in a reliable manner. On the other hand, when conduction of the N-type field effect transistor is in an OFF state, the step-down device lowers a voltage across the output line. In this instance, as the regulation switch controller controls the regulation switch to switch to an OFF state, the regulation switch regulates a flow of a current through the output line toward a portion to which the step-down device is connected. When configured in this manner, power outputted from the source to the load when conduction of the N-type field effect transistor is in an ON state can be supplied to the load in a reliable manner without being returned to the step-down device when conduction is switched to an OFF state. Hence, the power supply circuit having the regulation switch and the regulation switch controller in the current regulation device can continuously output power corresponding to a load condition of the load in a reliable manner.

Alternatively, the drive device may switch the conduction of the transistor to be the on-state when a voltage across the output line on a load side from the current regulation device is smaller than a predetermined threshold. In this case, in a case where the load is in a light load condition and an amount of power consumed by the load is therefore small, a voltage across the output line drops moderately. Hence, by configuring in such a manner, that conduction between the drain and the source is switched to an ON state by the drive device when a voltage across the output line on a side closer to the load than the current regulation device drops below a pre-set threshold, the voltage across the output line can be maintained within a pre-determined range. By allowing the drive device to repeat the operation as above, the power supply circuit becomes able to continuously output power corresponding to a light load condition of the load. Even in a case where the step-down device is connected to the output line of the power supply circuit as above, the step-down device can exert a function of securing a potential difference between the drive line and the output line by lowering a voltage across the output line. Hence, even in a case where a voltage of power supplied to the drive line drops, the drive device becomes able to switch conduction between the drain and the source to an ON state in a reliable manner by adding power supplied therein from the external power supply through the drive line to power charged to the charge device. Accordingly, by combining the drive device for switching conduction to an ON state when a voltage across the output line drops below the threshold and the step-down device for lowing a voltage across the output line, it become possible to achieve a power supply circuit capable of continuously outputting power corresponding to a light load condition of the load in a reliable manner.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. A power supply circuit comprising:
an N-type field effect transistor for outputting electricity to a load via a source of the transistor, the electricity supplied from an external power supply via a drain of the transistor, wherein the transistor controls conduction between the drain and the source to switch between an on-state and an off-state so that the transistor controls the electricity to be output via the source according to a load condition of the load;
a drive line for supplying the electricity from the external power supply to a gate of the transistor;
an output line for outputting the electricity from the source to the load;
a charge device for charging the electricity therein according to a potential difference between the drive line and the output line, wherein the charge device includes one end connecting to the drive line and the other end connecting to the output line;
a drive device disposed in the drive line, wherein the drive device applies a voltage to the gate higher than a voltage of the source with using the electricity supplied from the external power supply and the electricity charged in the charge device so that the transistor switches the conduction to be the on-state;
a step-down device connected to the output line, wherein the step-down device reduces a voltage across the output line when the conduction of the transistor is in the off-state; and
a current regulation device disposed in the output line on a load side from both of a connection between the step-down device and the output line and a connection between the charge device and the output line, wherein the current regulation device regulates a flow of current from the load toward the step-down device.

2. The power supply circuit according to claim 1,
wherein the step-down device includes:
a ground line having one end connected to the output line and the other end connected to a ground; and
an electric resistor disposed in the ground line.

3. The power supply circuit according to claim 1,
wherein the step-down device includes:
a ground line having one end connected to the output line and the other end connected to a ground;
a step-down switch disposed in the ground line and switching conduction of the ground line between an on-state and an off-state; and
a step-down switch controller controlling the step-down switch to be the on-state when the conduction of the transistor is in the off-state.

4. The power supply circuit according to claim 1,
wherein the current regulation device includes a diode disposed in the output line,
wherein the diode allows a flow of current from the source toward the load, and
wherein diode restricts a flow of current from the load toward the connection between the step-down device and the output line.

5. The power supply circuit according to claim 1,
wherein the current regulation device includes:
a regulation switch disposed in the output line and switching conduction of the output line between an on-state and an off-state; and
a regulation switch controller regulating a flow of current from the load toward the step-down device by controlling the regulation switch to be the off-state when the conduction of the transistor is in the off-state.

6. The power supply circuit according to claim 1,
wherein the drive device switches the conduction of the transistor to be the on-state when a voltage across the output line on a load side from the current regulation device is smaller than a predetermined threshold.

7. The power supply circuit according to claim 2, further comprising;
a low drop out regulator disposed in the drive line and transforming a voltage of the electricity from the external power supply to a predetermined voltage so that the low drop out regulator supplies the predetermined voltage to the drive device,
wherein the charge device is a capacitor having one end connecting to the drive line between the low drop out regulator and the drive device and the other end connecting to the output line between the transistor and the current regulation device.

8. The power supply circuit according to claim 7, further comprising:
a drive controller having one end connecting to the drive device and the other end connecting to the output line between the load and the current regulation device,
wherein the current regulation device includes a diode disposed in the output line,
wherein the diode allows a flow of current from the source toward the load,
wherein diode restricts a flow of current from the load toward the connection between the step-down device and the output line,
wherein the drive controller monitors the load condition of the load by detecting the voltage across the output line between the load and the current regulation device, and
wherein the drive controller controls the transistor via the drive device to switch between the on-state and the off-state.

9. The power supply circuit according to claim 3, further comprising;
a low drop out regulator disposed in the drive line and transforming a voltage of the electricity from the external power supply to a predetermined voltage so that the low drop out regulator supplies the predetermined voltage to the drive device,
wherein the charge device is a capacitor having one end connecting to the drive line between the low drop out regulator and the drive device and the other end connecting to the output line between the transistor and the current regulation device.

10. The power supply circuit according to claim 9, further comprising:
a drive controller having one end connecting to the drive device and the other end connecting to the output line between the load and the current regulation device,
wherein the current regulation device includes:
a regulation switch disposed in the output line and switching conduction of the output line between an on-state and an off-state; and
a regulation switch controller regulating a flow of current from the load toward the step-down device by controlling the regulation switch to be the off-state when the conduction of the transistor is in the off-state,
wherein the drive controller monitors the load condition of the load by detecting the voltage across the output line between the load and the current regulation device, and
wherein the drive controller controls the transistor via the drive device to switch between the on-state and the off-state.
